(19) United States
(12) Patent Application Publication
(10) Pub. No.: US 2025/0389042 A1
(43) Pub. Date: Dec. 25, 2025

(54) MENISCUS-CONFINED ELECTROCHEMICAL DEPOSITION DEVICES FOR HETEROGENEOUS METAL CORE-SHELL MICROSTRUCTURES AND METHODS

(71) Applicant: CHANGCHUN UNIVERSITY OF SCIENCE AND TECHNOLOGY, Changchun (CN)

(72) Inventors: Jinkai XU, Changchun (CN); Wanfei REN, Changchun (CN); Zhanjiang YU, Changchun (CN)

(73) Assignee: CHANGCHUN UNIVERSITY OF SCIENCE AND TECHNOLOGY, Changchun (CN)

(21) Appl. No.: 18/830,597

(22) Filed: Sep. 11, 2024

(30) Foreign Application Priority Data
Jun. 25, 2024 (CN) 202410824742.X

(51) Int. Cl. C25D 1/00; B33Y 10/00; B33Y 30/00; B33Y 50/02

(52) U.S. Cl. CPC C25D 1/003; B33Y 10/00; B33Y 30/00; B33Y 50/02

(57) ABSTRACT

Embodiments of the present disclosure provide a meniscus-confined electrochemical deposition device for a heterogeneous metal core-shell microstructure and a method, including a copper core structural system and a shell-layer structural system. The copper core structural system is used for a formation of a copper core structure, a microfine glass tube in the copper core structural system is mounted on a probe adjustment unit, and the probe adjustment unit is mounted on a macroscopic moving platform, which may realize micro-scale multi-material metal electrochemical deposition micro additive manufacturing. The shell-layer structural system is used for a formation of a shell layer structure, and the shell-layer structural system includes a plurality of reservoirs, which may realize a multi-layer core-shell structure covered with different metals, and flexible tuning of an electrochemical deposition device may be realized by adding different electrolyte reservoir supply systems.

### CROSS-REFERENCE TO RELATED APPLICATIONS

This application claims priority to Chinese application No. 202410824742.X, filed on Jun. 25, 2024, the entire contents of which are incorporated herein by reference.

### TECHNICAL FIELD

The present disclosure relates to the field of electrochemical deposition technology, and in particular, to a meniscus-confined electrochemical deposition device for a heterogeneous metal core-shell microstructure and a method.

### BACKGROUND

As an important advancement in localized electrochemical deposition techniques, the meniscus-confined electrochemical deposition method utilizes a microfine glass tube as a delivery channel for the electrolyte, forming a stable meniscus bridge with a cathode substrate. A shape of the meniscus bridge is controlled by moving a probe. Simultaneously, metal ions are converted into metal atoms under the influence of a two-electrode potentiometer, leading to the formation of metal microstructures. By continuously adjusting a spatial position of the probe, fabrication of complex microstructures is achieved.

Oriented toward the potential applications of large-area optical metasurfaces with active magnetically-controlled surface array units, the preparation of magnetically tunable heterogeneous metal core-shell structures on a microscopic scale holds significant promise. Utilizing resilient pure copper as the core structure in the core-shell configuration, the pure copper is shaped with high precision through meniscus-constrained electrochemical deposition, and the copper core structure is encapsulated with a nickel-metal shell. Presently, the formation of complex copper core structures through meniscus-confined electrochemical deposition remains challenging, and the regulation of metal shell structures is difficult, impeding the manufacturing of core-shell reinforced structures with active magnetically controlled surface array unit capabilities. Additionally, the current lack of equipment that may supply various specialized metal ion solutions on demand for meniscus-confined electrochemical deposition hampers the in-situ deposition of a plurality of materials. This shortfall makes it difficult to meet the demand for manufacturing tiny metal components such as solid copper pillars, hollow tubes, and spatial springs with conformally deposited nickel shells on their exterior surfaces.

Therefore, it is desired to provide a meniscus-confined electrochemical deposition device for a heterogeneous metal core-shell microstructure and a method to realize micro additive manufacturing of micro-scale multi-material metal electrochemical deposition as well as to realize a multi-layer core-shell structure covered with different metals and flexible tuning of the electrochemical deposition devices.

### SUMMARY

One or more embodiments of the present disclosure may provide a meniscus-confined electrochemical deposition device for a heterogeneous metal core-shell microstructure. The meniscus-confined electrochemical deposition device may include a macroscopic moving platform, a microscopic moving platform, a copper core structural system, a shell-layer structural system, a probe adjustment unit, and a central control unit. The macroscopic moving platform, the microscopic moving platform, the shell-layer structural system, and the central control unit may be disposed on a vibration isolation platform. The copper core structural system may include a microfine glass tube, a substrate, and a potentiometer, the microfine glass tube being configured to deliver an electrolyte, the substrate being configured to deposit a microstructure, and the potentiometer being configured to provide a three-electrode system to the copper core structural system. The microfine glass tube may be disposed on the probe adjustment unit, the probe adjustment unit may be disposed on the macroscopic moving platform, and the macroscopic moving platform may be configured to perform macro-range positional adjustment on the microfine glass tube; and the probe adjustment unit may be configured to perform small-range positional adjustment on the microfine glass tube. The shell-layer structural system may include an electrolytic cell, an electrochemical deposition power supply, and a plurality of reservoirs, a cathode of the electrochemical deposition power supply being connected to the substrate, and an anode of the electrochemical deposition power supply being connected to a sidewall of a pyrolytic graphite in the electrolytic cell, and the plurality of reservoirs may supply a plurality of electrolytes required for core-shell deposition to the electrolytic cell via an electrolyte-driven pump, respectively. The electrolytic cell may be disposed on the microscopic moving platform, the microscopic moving platform being configured to perform mobile adjustment on the electrolytic cell and the substrate and the pyrolytic graphite within the electrolytic cell. The central control unit may be electrically connected to electrical elements in the macroscopic moving platform, the microscopic moving platform, the copper core structural system, the shell-layer structural system, and the probe adjustment unit, and perform a coordinated control on the electrical elements.

One or more embodiments of the present disclosure may provide a meniscus-confined electrochemical deposition method for a heterogeneous metal core-shell microstructure. The meniscus-confined electrochemical deposition method may be implemented based on the meniscus-confined electrochemical deposition device. The method may include: injecting a copper sulfate solution into the microfine glass tube; forming a two-electrode electrochemical structure of the copper core structural system by the potentiometer, and forming a three-electrode electrochemical structure of the shell-layer structural system by the electrochemical deposition power supply; turning on a switch of the potentiometer to create a local electric field between the microfine glass tube and the substrate; adjusting a position of the microfine glass tube using the probe adjustment unit and the macroscopic moving platform to maintain an orthogonal state between the microfine glass tube and the substrate; extruding the copper sulfate solution placed inside the microfine glass tube into a deposition microzone of the substrate, controlling the microscopic moving platform to drive the substrate to move according to a meta-trajectory planning of a deposition body by the central control unit, and transforming metal ions to metal atoms under an action of the local electric field formed between the microfine glass tube and the substrate to form a copper metal complex metal deposition body and complete deposition of a copper core structure; the central control unit controlling the macroscopic moving platform to drive the probe adjustment unit and the microfine glass tube out of the electrolytic cell; and according to a design of a multilayer metal core-shell structure, the central control unit determining a thickness and a type of a metal core-shell layer, turning on the electrochemical deposition power supply, and controlling the electrolyte-driven pump to transport a metal solution in the plurality of reservoirs to the electrolytic cell in sequence according to a metal sequence of different types of metal core-shells to complete separate deposition of the different types of metal core-shells.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings:

FIG. 1 is an ortho-isometric view diagram of an exemplary meniscus-confined electrochemical deposition device for a heterogeneous metal core-shell microstructure according to some embodiments of the present disclosure;

FIG. 2 is a microzone view diagram of an exemplary electrolyzer tank of a meniscus-confined electrochemical deposition device for a heterogeneous metal core-shell microstructure according to some embodiments of the present disclosure;

FIG. 3 is a view diagram of an exemplary meniscus-confined electrochemical deposition electrolyte gating system for a heterogeneous metal core-shell microstructure according to some embodiments of the present disclosure;

FIG. 4 is a schematic diagram of an exemplary prediction model according to some embodiments of the present disclosure; and

FIG. 5 is a schematic diagram of an exemplary prediction model according to some other embodiments of the present disclosure.

In the figures:
1—a vibration isolation platform;
2—a macroscopic moving platform, 201—a Y-axis moving system, 202—a Z-axis moving system, 203—an X-axis moving system;
3—a microscopic moving platform, 301—an XY-direction moving platform, 302—a Z-direction moving platform;
4—a copper core structural system, 401—a pressure extrusion device, 402—an air delivery pipeline, 403—a potentiometer, 404—a microfine glass tube, 405—a substrate;
5—a shell-layer structural system, 501—an electrolytic cell, 502—an electrochemical deposition power supply, 503—an electrolyte delivery pipeline, 504—an electrolyte-driven pump, 505—a copper sulfate reservoir, 506—a nickel nitrate reservoir, 507—a recovery reservoir, 508—a zinc sulfate reservoir, 509—a silver nitrate reservoir, 510—a pyrolytic graphite;
6—a probe adjustment unit, 601—a micro-displacement adjustment mechanism, 602—a yaw adjustment mechanism, 603—a fixing bracket; and
7—a central control unit.

### DETAILED DESCRIPTION

In order to more clearly illustrate the technical solutions of the embodiments of the present disclosure, the accompanying drawings to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that as used herein, the terms “system”, “device”, “unit” and/or “module” are used herein as a way to distinguish between different components, elements, parts, sections, or assemblies at different levels. However, the words may be replaced by other expressions if other words accomplish the same purpose.

As shown in the present disclosure and in the claims, unless the context clearly suggests an exception, the words “a”, “an” and/or “the” do not refer specifically to the singular and may include the plural. Generally, the terms “including” and “comprising” suggest only the inclusion of clearly identified steps and elements, and these steps and elements do not constitute an exclusive list, and the method or apparatus may also include other steps or elements.

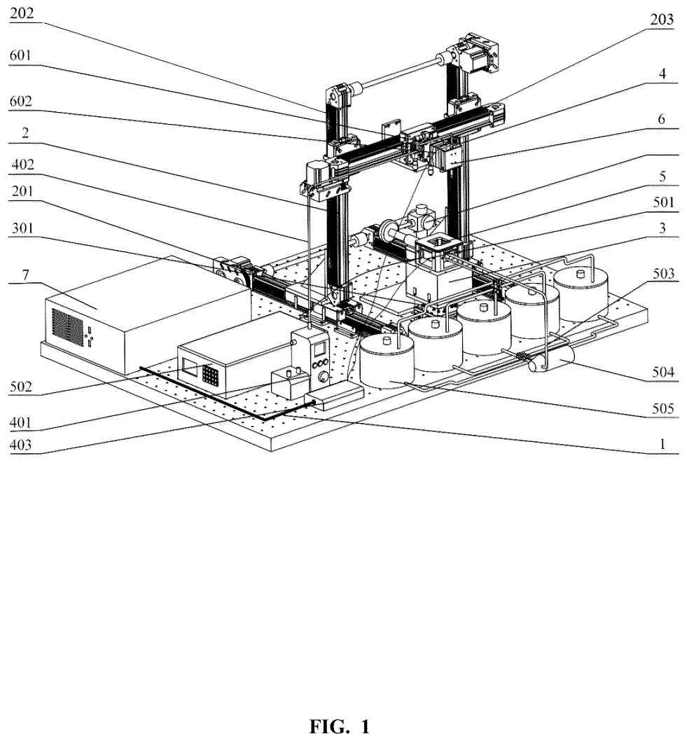

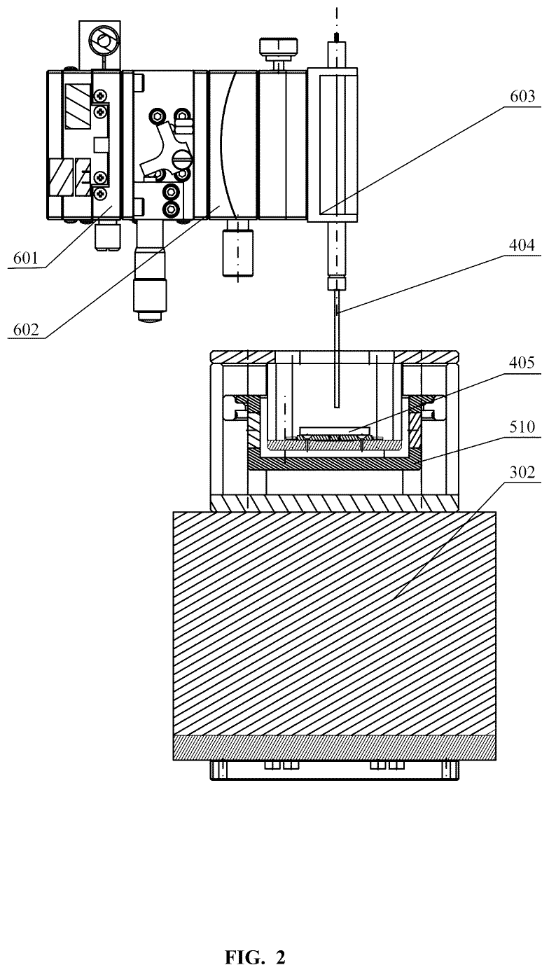

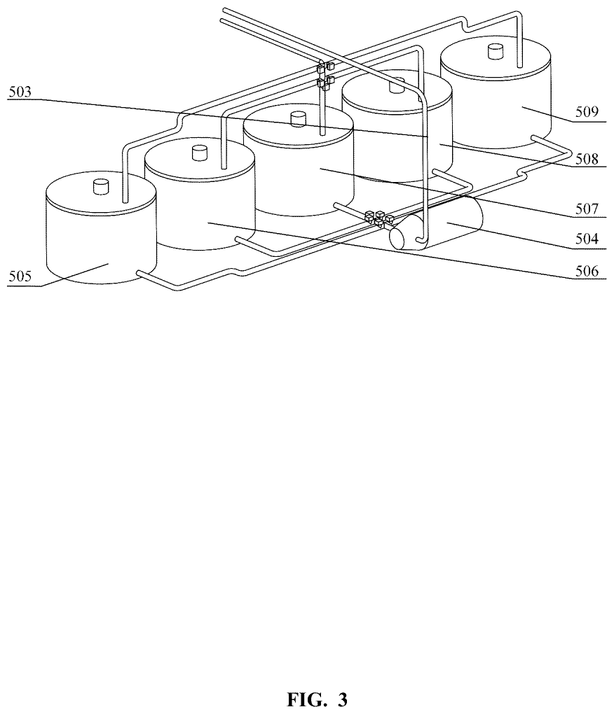

FIG. 1 is an ortho-isometric view diagram of an exemplary meniscus-confined electrochemical deposition device for a heterogeneous metal core-shell microstructure according to some embodiments of the present disclosure. FIG. 2 is a micro-area view diagram of an exemplary electrolyzer tank of a meniscus-confined electrochemical deposition device for a heterogeneous metal core-shell microstructure according to some embodiments of the present disclosure. FIG. 3 is a view diagram of an exemplary meniscus-confined electrochemical deposition electrolyte gating system for a heterogeneous metal core-shell microstructure according to some embodiments of the present disclosure.

Some embodiments of the present disclosure provide a meniscus-confined electrochemical deposition device for a heterogeneous metal core-shell microstructure (referred to as the “device”). As shown in FIGS. 1-3, the device includes a macroscopic moving platform (or referred to as a macroscopic three-dimensional moving platform) 2, a microscopic moving platform (or referred to as a microscopic three-dimensional moving platform) 3, a copper core structural system (or referred to as a meniscus-confined electrochemical deposition copper core structural system) 4, a shell-layer structural system (or referred to as a multi-metal shell structure deposition system) 5, a probe adjustment unit (or referred to as a probe position adjusting unit) 6, and a central control unit 7.

In some embodiments, the macroscopic moving platform 2, the microscopic moving platform 3, the shell-layer structural system 5, and the central control unit 7 are all disposed on a vibration isolation platform 1. For example, the macroscopic moving platform 2, the microscopic moving platform 3, the shell-layer structural system 5, and the central control unit 7 may be placed or fixedly connected to the vibration isolation platform 1.

The vibration isolation platform 1 may support, mount, and dampen the overall device. In some embodiments, the vibration isolation platform 1 may include a work surface (e.g., a platform panel, or the like) and a vibration isolation support element. Exemplary vibration isolation support elements include, but are not limited to, air springs, rubber, or the like.

The copper core structural system 4 is used for a formation of a copper core structure. In some embodiments, the copper core structural system 4 may include a microfine glass tube 404, a substrate 405, and a potentiometer 403. In some embodiments, the microfine glass tube 404 is configured to deliver an electrolyte, the substrate 405 is configured to a deposit a microstructure, and the potentiometer 403 is configured to provide a three-electrode system to the copper core structural system.

The potentiometer 403 refers to a resistor used to regulate a voltage or a current. In some embodiments, the potentiometer 403 may participate in an operation of the three-electrode system by providing an applied potential to drive an electrochemical reaction. An electrochemical three-electrode system consists of a working electrode, a reference electrode, and an auxiliary electrode (also known as a counter electrode).

The working electrode is an electrode that is in direct contact with the electrolyte and is a main site of the electrochemical reaction. The reference electrode is an electrode that provides a stable potential reference for correcting potential variations of the working electrode, ensuring the accuracy of the measurement. The auxiliary electrode is an electrode used to provide a current, ensuring that the electrochemical reactions occur on the working electrode. It should be noted that the working electrode may be either a cathode or an anode, depending on an actual situation. When the working electrode serves as the cathode, the auxiliary electrode corresponding to the working electrode serves as the anode.

In some embodiments, the microfine glass tube 404 is disposed on a probe adjustment unit 6, the probe adjustment unit 6 is disposed on the macroscopic moving platform 2, and the macroscopic moving platform 2 is configured to perform macro-range positional adjustment on the microfine glass tube 404.

In some embodiments, the probe adjustment unit 6 is configured to perform small-range positional adjustment on the microfine glass tube 404. By adjusting the position of the microfine glass tube 404 using the probe adjustment unit 6 and the macroscopic moving platform 2, the microfine glass tube 404 may positioned within an electrolytic cell 501 and maintain an orthogonal state with the substrate 405 during the copper core structure deposition, and exit the electrolytic cell 501 at the end of the copper core structure deposition.

In some embodiments, the substrate 405 is disposed at a bottom of the electrolytic cell 501, an anode of the potentiometer 403 is inserted into a copper sulfate solution inside the microfine glass tube 404, and a cathode of the potentiometer 403 is connected to the substrate 405 to form a two-electrode electrochemical structure of the copper core structural system 4. By turning on a switch of the potentiometer 403, a local electric field may be created between the microfine glass tube 404 and the substrate 405, and then the copper sulfate solution placed inside the microfine glass tube 404 may be extruded into a deposition microzone of the substrate 405.

In some embodiments, the central control unit 7 controls the microscopic moving platform 3 to drive the substrate 405 to move according to a meta-trajectory planning of a deposition body, and under an action of the local electric field formed between the microfine glass tube 404 and the substrate 405, transforms metal ions to metal atoms to form a copper metal complex metal deposition body and completes the copper core structure deposition.

The meta-trajectory planning of the deposition body refers to a path planning for controlling the trajectory of the microscopic moving platform 3 in the three-dimensional space to form the deposition body. In some embodiments, the meta-trajectory planning of the deposition body may be obtained by operator input.

The shell-layer structural system 5 is used for a formation of a shell structure. In some embodiments, the shell-layer structural system 5 includes an electrolytic cell 501, an electrochemical deposition power supply 502, and a plurality of reservoirs. A cathode of the electrochemical deposition power supply 502 is connected to the substrate 405. An anode of the electrochemical deposition power supply 502 is connected to a sidewall of a pyrolytic graphite 510 of the electrolytic cell 501. A reference electrode of the electrochemical deposition power supply 502 is placed in the electrolytic cell 501 without contact with the sidewall and the substrate 405, and a three-electrode electrochemical structure of the shell-layer structural system 5 is formed by the electrochemical deposition power supply 502. The pyrolytic graphite 510 is a special graphite formed by pyrolysis of hydrocarbons at 2200° C., which may be used as an electrode material for the electrolytic cell 501.

The electrolytic cell 501 refers to a device for converting electrical energy into chemical energy. In some embodiments, the electrolytic cell 501 is disposed on the microscopic moving platform 3. The microscopic moving platform 3 is configured to perform mobile adjustment on the electrolytic cell 501 and the substrate 405 and the pyrolytic graphite 510 within the electrolytic cell 501.

The reservoir is a structural member for storing an electrolyte. In some embodiments, the plurality of reservoirs may be used to store a plurality of different electrolytes. The structural shape of the reservoirs is not limited, including, but not limited to cylindrical, box-shaped, or the like.

The central control unit 7 refers to a module or component for controlling other components in the device. In some embodiments, the central control unit 7 may include a processor. The processor may process data and/or information obtained from other devices or components of the device. The processor may execute program instructions based on data, information, and/or processing results to execute one or more functions described in the present disclosure.

In some embodiments, the processor may include one or more sub-processing devices (e.g., a single-core processing device or a multi-core processing device). Merely by way of example, the processor may include a central processor, a controller, a microcontroller unit, a microprocessor, or the like, or any combination thereof.

In some embodiments, the central control unit 7 may be electrically connected to electrical components in the macroscopic moving platform 2, the microscopic moving platform 3, the copper core structural system 4, the shell-layer structural system 5, and the probe adjustment unit 6, and each of the electrical components may be coordinated controlled. For example, the central control unit 7 may control the microscopic moving platform 3 to drive the substrate 405 to move based on the meta-trajectory planning of the deposition body.

For more descriptions on the meniscus-confined electrochemical deposition device for a heterogeneous metal core-shell microstructure, refer to related descriptions below.

In some embodiments, as shown in FIG. 1, the macroscopic moving platform 2 includes a Y-axis moving system (or referred to as a macroscopic Y-axis moving system) 201, a Z-axis moving system (or referred to as a macroscopic Z-axis moving system) 202, and an X-axis moving system (or referred to as a macroscopic X-axis moving system) 203. The Z-axis moving system 202 is disposed on the vibration isolation platform 1 through a connecting member and provided with left and right pillars, the two pillars together holding up the Y-axis moving system 201, and the X-axis moving system 203 is disposed on the Y-axis moving system 201.

The Y-axis moving system 201, the Z-axis moving system 202, and the X-axis moving system 203 refer to systems for realizing a wide range of movement of the microfine glass tube 404 in X-axis, Y-axis, and Z-axis directions, respectively. In some embodiments, the Y-axis moving system 201, the Z-axis moving system 202, and the X-axis moving system 203 may realize the function of driving the microfine glass tube 404 to be moved in the X-axis, Y-axis, and Z-axis directions, respectively, in various ways, for example, by using a ball screw structure, a motorized telescopic rod, or the like.

The connecting member refers to an element used to securely connect the Z-axis moving system 202 and the vibration isolation platform 1. For example, the connecting member may include bolts, screws, or the like.

In some embodiments, the X-axis moving system 203 may be drive-connected to the Y-axis moving system 201, and the X-axis moving system 203 may move in the Y-axis direction on the Y-axis moving system 201.

According to some embodiments of the present disclosure, the wide range of movement of the microfine glass tube 404 in the X-axis direction may be realized by the X-axis moving system 203; the wide range of movement of the microfine glass tube 404 in the Y-axis direction may be realized by the Y-axis moving system 201; and the wide range of movement of the microfine glass tube 404 in the Z-axis direction may be realized by the Z-axis moving system 202, so as to move the microfine glass tube 404 to a suitable position (e.g., above the electrolytic cell 501, or the like).

In some embodiments, as shown in FIG. 2, the probe adjustment unit 6 includes a micro-displacement adjustment mechanism (or referred to as an attitude micro-displacement adjustment mechanism) 601, a yaw adjustment mechanism (or referred to as an attitude yaw adjustment mechanism) 602, and a fixing bracket (or referred to as a probe adjustment unit fixing bracket) 603.

In some embodiments, the fixing bracket 603 is disposed on the X-axis moving system 203, the micro-displacement adjustment mechanism 601 is disposed on the fixing bracket 603, the yaw adjustment mechanism 602 is disposed on the micro-displacement adjustment mechanism 601, and the microfine glass tube 404 is disposed on a bracket of the yaw adjustment mechanism 602.

The micro-displacement adjustment mechanism 601 refers to a mechanism for realizing a tiny range of movement of the microfine glass tube 404 in the X-axis, Y-axis, and Z-axis directions. The yaw adjustment mechanism 602 refers to a mechanism for adjusting a mounting angle of the microfine glass tube 404. The fixing bracket 603 is a bracket for fixing the micro-displacement adjustment mechanism 601 to the X-axis moving system 203.

According to some embodiments of the present disclosure, the macroscopic moving platform 2 may realize the wide range of movement of the microfine glass tube 404 by moving the probe adjustment unit 6 as a whole. The micro-displacement adjustment mechanism 601 is a finer three-dimensional displacement platform, and by the micro-displacement adjustment mechanism 601, it is possible to realize movement of the microfine glass tube 404 in a micrometer precision range in the X-axis, Y-axis, and Z-axis directions. Therefore, by adjusting the mounting angle of the microfine glass tube 404 by the yaw adjustment mechanism 602, it may be further ensured that the microfine glass tube 404 is finally in a target position.

In some embodiments, as shown in FIGS. 1-2, the microscopic moving platform 3 includes an XY-direction moving platform (or referred to as a microscopic XY-direction moving platform) 301 and a Z-direction moving platform (or referred to as a microscopic Z-direction moving platform) 302. The XY-direction moving platform 301 is disposed on the vibration isolation platform 1, and the Z-direction moving platform 302 is disposed on the XY-direction moving platform 301.

In some embodiments, the XY-direction moving platform 301 may be used to move the electrolytic cell 501 in the X and Y directions, and the Z-direction moving platform 302 may be used to move the electrolytic cell 501 in the Z direction. In some embodiments, the XY-direction moving platform 301 may be disposed on the vibration isolation platform 1 through a snap connection, a bonding connection, a threaded connection, or the like. The Z-direction moving platform 302 is disposed on the XY-direction moving platform 301 and is drive-connected to the XY-direction moving platform 301.

According to some embodiments of the present disclosure, positional adjustment of the electrolytic cell 501 can be realized by providing the microscopic moving platform 3. At the same time, the central control unit 7 controls the relative movement of the macroscopic moving platform 2 and the microscopic moving platform 3, which can improve a moving rate to a certain extent.

In some embodiments, as shown in FIG. 1, the copper core structural system 4 further includes a pressure extrusion device (or referred to as a pulsed pressure extrusion device) 401 and an air delivery pipeline 402. The pressure extrusion device 401 is disposed on the vibration isolation platform 1, and one end of the air delivery pipeline 402 is connected to an outlet of the pressure extrusion device 401, and the other end of the air delivery pipeline 402 is connected to the microfine glass tube 404.

The pressure extrusion device 401 refers to a device for controlling the extrusion of the copper sulfate solution within the microfine glass tube 404. The air delivery pipeline 402 refers to a pipeline for connecting the outlet of the pressure extrusion device 401 and the microfine glass tube 404.

In some embodiments, the pressure extrusion device 401 may cause the copper sulfate solution within the microfine glass tube 404 to be extruded by increasing the air in the air delivery pipeline 402. An extruded amount of the copper sulfate solution is correlated to an incremental amount of air in the air delivery pipeline 402. The greater the incremental amount of air, the greater the extruded amount of the copper sulfate solution. Notably, a specific correlation between the extruded amount of the copper sulfate solution and the incremental amount of air in the air delivery pipeline 402 may be determined based on a diameter of the air delivery pipeline 402 and the microfine glass tube 404.

In some embodiments, after an operator injects the copper sulfate solution into the microfine glass tube 404, the central control unit 7 may control the pressure extrusion device 401 to extrude the copper sulfate solution in the microfine glass tube 404 into a microdepositional zone of the substrate 405.

In some embodiments, as shown in FIG. 1 and FIG. 3, the shell-layer structural system 5 further includes an electrolyte delivery pipeline 503 and an electrolyte-driven pump 504. Two ends of the electrolyte delivery pipeline 503 are connected to the electrolytic cell 501 and the plurality of reservoirs, respectively, and the electrolyte-driven pump 504 is disposed on the electrolyte delivery pipeline 503.

The electrolyte delivery pipeline 503 refers to a pipeline used to convey the electrolyte. A material of the electrolyte delivery pipeline 503 may be glass or other materials that do not react with the electrolyte.

The electrolyte-driven pump 504 refers to a device for pumping the electrolyte into the electrolytic cell 501 or for recovering a remaining metal solution from the electrolytic cell 501.

In some embodiments, the plurality of reservoirs are respectively provided with a plurality of electrolytes required for core-shell deposition to the electrolytic cell 501 via the electrolyte-driven pump 504, and core-shell metals used in this embodiment are copper, nickel, zinc, and silver, and the corresponding electrolytes required for the core-shell deposition are a copper sulfate solution, a nickel nitrate solution, a zinc sulfate solution, and a silver nitrate solution. The copper sulfate solution, the nickel nitrate solution, the zinc sulfate solution, and the silver nitrate solution are placed in a copper sulfate reservoir 505, a nickel nitrate reservoir 506, a zinc sulfate reservoir 508, and a silver nitrate reservoir 509, respectively, and there is also provided an empty reservoir as a recovery reservoir 507 for the recovery of the remaining metal solution (i.e., the remaining electrolyte).

It is worth noting that concentrations of different types of the electrolytes described above (i.e., electrolyte concentrations) may be the same or different. More description on the electrolyte concentrations may be found in the later description.

In some embodiments, positive rotation of the electrolyte-driven pump 504 may pump the electrolyte within the reservoir into the electrolytic cell 501, and reverse rotation of the electrolyte-driven pump 504 may pump the remaining electrolyte within the electrolytic cell 501 into the recovery reservoir 507. The recovery reservoir 507 refers to a structural member for storing a remaining metal solution.

According to some embodiments of the present disclosure, the copper core structural system is used for the formation of the copper core structure, and the microfine glass tube in the copper core structural system is mounted on the probe adjustment unit, which is mounted on the macroscopic moving platform, thereby realizing tiny-scale multi-material metal electrochemical deposition micro additive manufacturing.

The shell-layer structural system is used for the formation of the shell structure. The shell-layer structural system includes the plurality of reservoirs to realize a multi-layer core-shell structure covered with different metals. Flexible tuning of an electrochemical deposition device may be realized by adding different electrolyte reservoir supply systems. The different electrolyte reservoir supply systems may be installed on the original electrochemical deposition device, which has a certain expansion and demonstration effect on the original electrochemical deposition device.

The present disclosure also provides a meniscus-confined electrochemical deposition method for a heterogeneous metal core-shell microstructure, which is implemented based on the above-described meniscus-confined electrochemical deposition device for the heterogeneous metal core-shell microstructure. The method may include following operations.

Step 1: a copper sulfate solution of 0.5 M (Mol/L) may be injected into the microfine glass tube 404.

In some embodiments, an operator may utilize a syringe to inject the copper sulfate solution into the microfine glass tube 404, mount the microfine glass tube 404 on the fixing bracket 603, and mount the air delivery pipeline 402 at an upper end of the microfine glass tube 404.

More descriptions on the microfine glass tube, the fixing bracket, and the air delivery pipeline may be found in the previous descriptions (e.g., FIGS. 1-3 and related descriptions thereof).

Step 2: a two-electrode electrochemical structure of the copper core structural system 4 may be formed by the potentiometer 403, and a three-electrode electrochemical structure of the shell-layer structural system 5 may be formed by the electrochemical deposition power supply 502.

In some embodiments, forming the two-electrode electrochemical structure of the copper core structural system 4 by the potentiometer 403 includes: inserting an anode of the potentiometer 403 into the copper sulfate solution inside the microfine glass tube 404, and connecting a cathode of the potentiometer 403 to the substrate 405 provided at the bottom of the electrolytic cell 501.

In some embodiments, forming the three-electrode electrochemical structure of the shell-layer structural system 5 by the electrochemical deposition power supply 502 includes: connecting the cathode of the electrochemical deposition power supply 502 to the substrate 405, connecting the anode of the electrochemical deposition power supply 502 to the sidewall of the pyrolytic graphite 510 of the electrolytic cell 501, and placing the reference electrode of the electrochemical deposition power supply 502 in the electrolytic cell 501 without contact with the sidewall of the pyrolytic graphite 510 and the substrate 405.

More descriptions on the copper core structural system and the shell-layer structural system may be found in the previous descriptions (e.g., FIGS. 1-3 and related descriptions thereof).

Step 3: the switch of the potentiometer 403 may be turned on to create a local electric field between the microfine glass tube 404 and the substrate 405.

Step 4: a position of the microfine glass tube 404 may be adjusted using the probe adjustment unit 6 and the macroscopic moving platform 2 to maintain an orthogonal state between the microfine glass tube 404 and the substrate 405.

In some embodiments, the position of the microfine glass tube 404 is adjusted by the probe adjustment unit 6 and the macroscopic moving platform 2 so that the microfine glass tube 404 is located directly above a center of the substrate 405, and an orthogonal state between the microfine glass tube 404 and the substrate 405 is maintained. Specifically, the spatial positions of the Z-axis moving system 202, the X-axis moving system 203, the Y-axis moving system 201, the XY-direction moving platform 301, and the Z-direction moving platform 302 are adjusted by the central control unit 7, so that the microfine glass tube 404 is located directly above the center of the substrate 405, and a distance between an end of the microfine glass tube 404 and the substrate 405 is in a range of 10 μm˜15 μm. The micro-displacement adjustment mechanism 601 and the yaw adjustment mechanism 602 may be adjusted to maintain the orthogonal state between the microfine glass tube 404 and the substrate 405, that is, to maintain the microfine glass tube 404 perpendicular to the substrate 405.

More descriptions on the macroscopic moving platform may be found in the previous descriptions (e.g., FIGS. 1-3 and related descriptions thereof).

Step 5: the copper sulfate solution placed inside the microfine glass tube 404 may be extruded into the deposition microzone of the substrate 405, the microscopic moving platform 3 may be controlled to drive the substrate 405 to move according to the meta-trajectory planning of the deposition body by the central control unit 7, and metal ions to metal atoms may be transformed under an action of the local electric field formed between the microfine glass tube 404 and the substrate 405 to form a copper metal complex metal deposition body and complete deposition of the copper core structure.

In some embodiments, the central control unit 7 realizes the movement of the electrolytic cell 501 and the substrate 405 disposed at the bottom of the electrolytic cell 501 by controlling the movement of the XY-direction moving platform 301 and the Z-direction moving platform 302.

More descriptions on the central control unit and the microscopic moving platform may be found in the previous descriptions (e.g., FIGS. 1-3 and related descriptions thereof).

Step 6: the central control unit 7 may control the macroscopic moving platform 2 to drive the probe adjustment unit 6 and the microfine glass tube 404 out of the electrolytic cell 501, and drive the microfine glass tube 404 to move to a position 10 cm above the electrolytic cell 501.

Step 7: according to a design of a multilayer metal core-shell structure, the central control unit may determine a thickness and a type of a metal core-shell layer, turn on the electrochemical deposition power supply, and control the electrolyte-driven pump to transport a metal solution in the plurality of reservoirs to the electrolytic cell in sequence according to a metal sequence of a core-shell to complete separate deposition of different types of metal core-shells.

The multilayer metal core-shell structure refers to a nanoscale ordered assembled structure formed by one or more metallic materials encapsulating another metallic material (e.g., a core-shell metal) through chemical bonding or other forces. In some embodiments, the multilayer metal core-shell structure may be designed based on actual needs or the like. For example, if a multilayer metal core-shell structure with a high thermal stability and mechanical strength is desired, the thickness of the metal core-shell may be increased accordingly.

In some embodiments, the central control unit 7 may be manually entered or set by an operator to obtain the design of the multilayer metal core-shell structure.

The core-shell metals used in the present embodiment are copper, nickel, zinc, and silver, respectively, and the corresponding electrolytes required for the deposition of the core-shells are the copper sulfate solution, the nickel nitrate solution, the zinc sulfate solution, and the silver nitrate solution, respectively. Therefore, a zinc sulfate solution with a concentration of 0.3M, a silver nitrate solution with a concentration of 0.2M, a copper sulfate solution with a concentration of 0.5M, a nickel nitrate solution with a concentration of 0.3M need to be provided in advance, and then the copper sulfate solution is placed into the copper sulfate reservoir 505, the nickel nitrate solution is placed into the nickel nitrate reservoir 506, the zinc sulfate solution is placed into the zinc sulfate reservoir 508, and the silver nitrate solution is placed into the silver nitrate reservoir 509, respectively.

When the shell-layer structural system 5 begins to work, the central control unit 7 may determine thicknesses of a copper layer, a nickel layer, a zinc layer, and a silver layer, respectively, according to the design of the multilayer metal core-shell structure, and then transport the corresponding metal solution in the corresponding reservoir through the electrolyte delivery pipeline 503 to the electrolytic cell 501 in sequence according to the metal sequence of the core-shells by controlling the electrolyte-driven pump 504, thereby realizing the separate deposition of the different types of metal core-shells.

It is worth noting that when the design of the multilayer metal core-shell structure is different, the type of the metal core-shell and the type and concentration of the corresponding electrolyte required for the deposition of the core-shell may be different. Furthermore, when the thickness of the metal core-shell is different, a time for the completion of the deposition of the metal core-shell may be different, which is not limited by the present disclosure.

In some embodiments, the plurality of the reservoirs may include an empty reservoir as the recovery reservoir 507 for recycling the remaining metal solution. In some embodiments, in response to completion of each deposition of one type of the metal core-shell, the central control unit 7 may control the electrolyte-driven pump 504 to reverse and empty the remaining metal solution in the electrolytic cell 501 to the recovery reservoir 507.

In some embodiments, the central control unit 7 may determine whether or not to complete the deposition of one type of the metal core-shell based on the design of the multilayer metal core-shell structure, and in response to the completion of each deposition of one type of the metal core-shell, automatically control the electrolyte-driven pump 504 to reverse using a customized program instruction, thereby emptying the remaining metal solution in the electrolytic cell 501 into the recovery reservoir 507.

In some embodiments, prior to use of the device, the operator may soak the substrate 405 in an acetone solution for ultrasonic cleaning for 120 s, rinse the substrate 405 twice with isopropyl alcohol to remove organic impurities, and then rinse the substrate 405 twice with deionized water to remove inorganic impurities. After use of the device, the operator may remove the deposited substrate 405 with tweezers and rinse the deposited substrate 405 with isopropyl alcohol and deionized water to remove impurities, and then turn off the potentiometer 403 and the electrochemical deposition power supply 502.

It should be noted that the above specific values involved in how to clean the device before the device is used are only examples, which is not limited in the present disclosure.

The meniscus-confined electrochemical deposition device for a heterogeneous metal core-shell microstructure and method provided by the present disclosure may realize switching of 3 modes by controlling metal ion supply from different electrolyte reservoirs. For example, the first mode includes: realizing the fabrication of a single metal complex microstructure; the second mode includes: realizing the fabrication of the single metal complex microstructure and forming a multilayered metal-covered core-shell structure on an outer surface thereof, with the count of layers of the core-shell and the metal type being controllable; and the third mode includes: realizing multilayer metal plating based on deposition of different metal materials on the substrate 405.

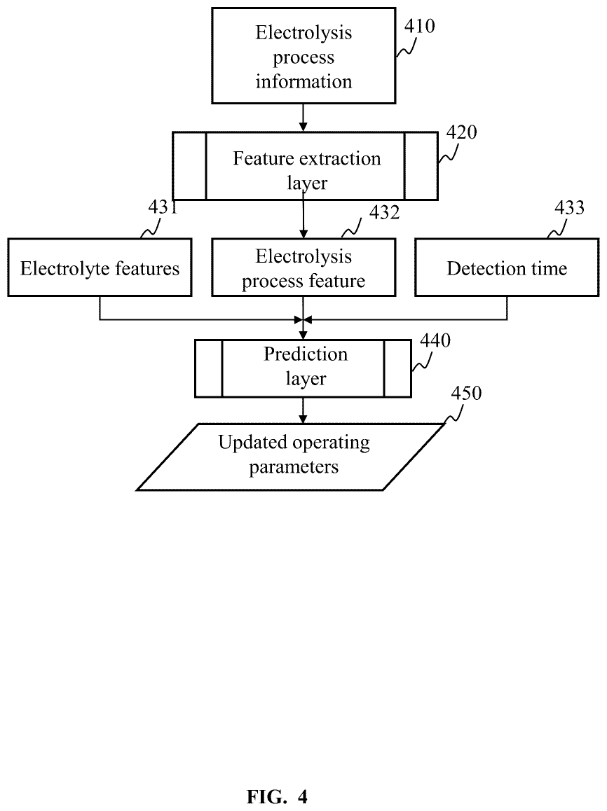

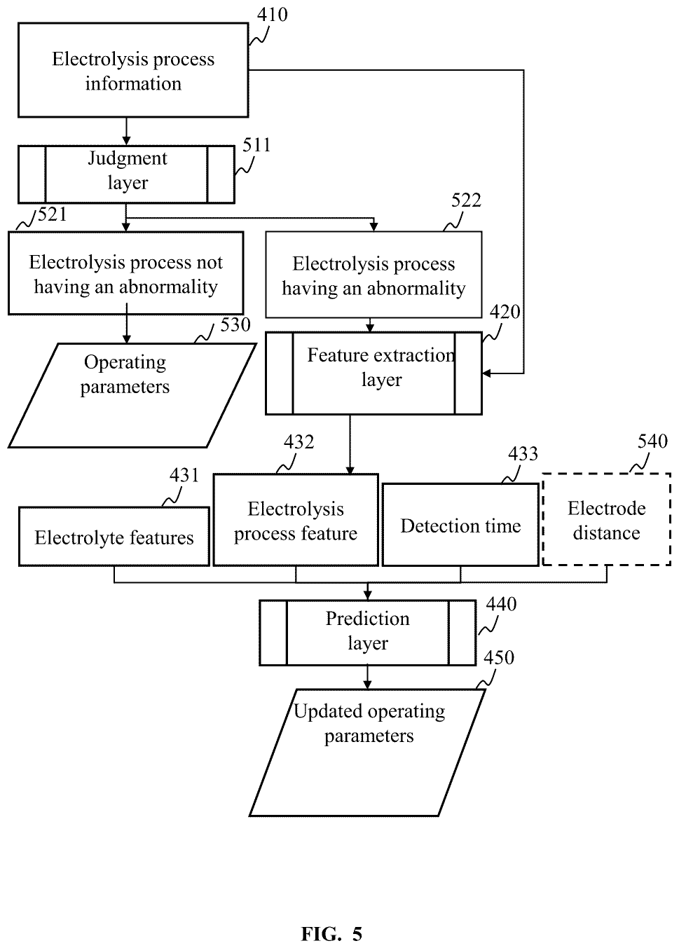

More descriptions on the meniscus-confined electrochemical deposition method for the heterogeneous metal core-shell microstructure may be found in the subsequent descriptions (e.g., FIGS. 4-5 and related descriptions thereof).

In some embodiments, the central control unit may determine operating parameters of the potentiometer based on electrolyte features and control the potentiometer to operate at the operating parameters.

More descriptions on the central control unit and the potentiometer may be found in the previous descriptions (e.g., FIGS. 1-3 and related descriptions thereof).

The electrolyte features refer to features associated with the electrolyte. In some embodiments, the electrolyte features may include an electrolyte property, an electrolyte concentration, and an electrolyte volume.

The electrolyte property refers to a type of the electrolyte. For example, the electrolyte property may include copper sulfate, nickel nitrate, zinc sulfate, silver nitrate, or the like.

The electrolyte concentration refers to an amount of electrolytes in the electrolyte. In some embodiments, the electrolyte concentration may be expressed as molar concentration (M).

The electrolyte volume refers to a volume of solution used to participate in the electrolysis process. In some embodiments, the electrolyte volume may be expressed in milliliters (ml).

In some embodiments, the electrolyte features may be obtained based on manual input by the operator.

The operating parameters of the potentiometer refer to relevant parameters used to control the operation of the potentiometer. In some embodiments, the operating parameters of the potentiometer may include a current and a voltage of the potentiometer.

In some embodiments, the central control unit may determine the operating parameters of the potentiometer via a preset table based on the electrolyte features.

The preset table may be used to characterize a correlation between the electrolyte features and the operating parameters of the potentiometer, with each set of electrolyte features corresponding to a set of operating parameters of the potentiometer (hereafter referred to as reference operating parameters). In some embodiments, the preset table may be constructed through experimentation, historical data, or the like. For example, for the same set of the electrolyte features, the operator may conduct electrolysis tests using different operating parameters and use the operating parameters corresponding to best copper core structure deposition and the highest reaction efficiency as the reference operating parameters.

In some embodiments, the operator may determine the effect of the copper core structure deposition by, for example, examining the uniformity and smoothness of the appearance of the deposition body, the uniformity of the thickness of the deposition body, or examining the composition and purity of the deposition body.

In some embodiments, the central control unit may determine the operating parameters of the potentiometer based on the electrolyte features through a prediction model.

In some embodiments, the prediction model may be used to predict the operating parameters of the potentiometer. In some embodiments, the prediction model may be a machine learning model. For example, the prediction model may include one or a combination of a Deep Neural Network (DNN) model, a Convolutional Neural Network (CNN) model, or the like.

In some embodiments, an input of the prediction model may include the electrolyte features, and an output of the prediction model may include the operating parameters of the potentiometer.

In some embodiments, the prediction model may be obtained by training based on a large number of first training samples with a first label. The first training samples may include sample electrolyte features, and the first label may include actual operating parameters of the potentiometer corresponding to the first training samples.

In some embodiments, the first training samples may be determined based on historical data, and the first label may be obtained in a manner similar to that of determining the reference operating parameters in the preset table described above, which will not be described herein.

In some embodiments, the central control unit may input the first training samples into an initial prediction model, iterate parameters of the initial prediction model through training until the trained model satisfies preset training conditions, and obtain a trained prediction model. The preset training conditions may be a loss function less than a threshold, convergence, or a training period reaching a threshold. In some embodiments, the manner of iteratively updating the parameters of the prediction model may include a stochastic gradient descent algorithm.

In some embodiments, the central control unit may control the potentiometer to operate at the operating parameters by executing a custom program code.

In some embodiments, the meniscus-confined electrochemical deposition device for the heterogeneous metal core-shell microstructure may further include an electrolysis detection device (not shown in the figures), which is disposed on an inner wall of the electrolytic cell and is configured to obtain electrolysis process information of the electrolyte.

The electrolysis process information of the electrolyte refers to a relevant parameter reflecting the electrolytic process of the electrolyte. For example, the electrolysis process information includes an ion concentration, a PH value, a temperature, or the like.

The electrolysis detection device refers to a device for collecting the electrolysis process information of the electrolyte. For example, the electrolysis detection device may include an electrochemical sensor, a PH sensor, a temperature sensor, or the like.

In some embodiments, the central control unit may also determine updated operating parameters of the potentiometer based on the electrolysis process information and the electrolyte features at a certain detection time through the prediction model and control the potentiometer to operate at the updated operating parameters.

The detection time refers to a length of time that the electrolyte has been electrolyzed at the time of obtaining the electrolysis process information. For example, if the electrolysis process information is acquired when the electrolyte has been electrolyzed for 1 min, then the detection time is 1 min.

In some embodiments, the detection time may be obtained by manual input by the operator. In some embodiments, the central control unit may also directly read the detection time for the electrolysis detection device to obtain the electrolysis process information.

The updated operating parameters refer to operating parameters which have been adjusted and updated.

In some embodiments, the prediction model may also be used to predict the updated operating parameters of the potentiometer. For more description on the prediction model, refer to the previous description thereof.

FIG. 4 is a schematic diagram of an exemplary prediction model according to some embodiments of the present disclosure. As shown in FIG. 4, the prediction model includes a feature extraction layer 420 and a prediction layer 440. An input of the feature extraction layer 420 may include electrolysis process information 410, and an output of the feature extraction layer 420 may include an electrolysis process feature 432. An input of the prediction layer 440 may include electrolyte features 431, the electrolysis process feature 432, and a detection time 433, and an output of the prediction layer 440 may include updated operating parameters 450 of the potentiometer.

The electrolysis process feature refers to a relevant feature that reflects a current electrolysis situation. For more description on the electrolyte features, refer to the previous description thereof.

In some embodiments, the feature extraction layer and the prediction layer of the prediction model may be obtained by joint training based on a large number of second training samples with a second label.

In some embodiments, the second training samples may include sample electrolysis process information, sample electrolyte features, and a sample detection time, and the second label may include actual updated operating parameters of the potentiometer corresponding to the second training samples.

In some embodiments, the second training sample may be determined based on historical data. The sample electrolysis process information may be selected when there is an abnormality in the electrolysis process, such as temperature data that exceeds a temperature threshold.

In some embodiments, the operator may select the operating parameters of the potentiometer when electrolysis is restored to normal after the adjustment and when the deposition is the best and the reaction efficiency is qualified as the second label by adjusting the operating parameters of the potentiometer corresponding to the second training samples.

In some embodiments, during joint training, the central control unit may input the sample electrolysis process information to the feature extraction layer, obtain the electrolysis process feature output from the feature extraction layer, and then use the electrolysis process feature output from the feature extraction layer as training sample data and input into the prediction layer with the sample electrolyte features and the sample detection time, obtain the updated operating parameters of the potentiometer output from the prediction layer, construct a loss function based on the second label and an output of the prediction layer, and synchronously update parameters of the feature extraction layer and the prediction layer until the loss function satisfies preset training conditions, and then obtain a trained feature extraction layer and a trained prediction layer.

The predetermined training conditions may be that the loss function is less than a threshold, converges, or the training period reaches a threshold. In some embodiments, the manner of iteratively updating the parameters of the prediction model may include a conventional model training manner such as a stochastic gradient descent algorithm.

In some embodiments, the central control unit may control the potentiometer to operate with the updated operating parameters by executing custom program code.

According to some embodiments of the present disclosure, by using a trained prediction model to judge the electrolysis process in advance, more accurate updated operating parameters of the potentiometer may be obtained, which is conducive to adjusting the operating parameters of the potentiometer in a timely manner, to ensure the reaction efficiency of the electrolysis process, and to enhance the deposition effect. Meanwhile, the safety of the electrolysis process is ensured. By means of joint training, an amount of sample data may also be reduced, saving computational resources.

In some embodiments, the central control unit may further determine whether there is an abnormality in the electrolysis process of the electrolyte through the prediction model based on the electrolysis process information acquired in real time; and in response to determining that there is the abnormality in the electrolysis process, determine the updated operating parameters of the potentiometer through the prediction model.

FIG. 5 is a schematic diagram of an exemplary prediction model shown according to some other embodiments of the present disclosure. As shown in FIG. 5, the prediction model may include a judgment layer 511, the feature extraction layer 420, and the prediction layer 440. An input of the judgment layer 511 may include the electrolysis process information 410 acquired in real time, and an output of the judgment layer 511 may include an electrolysis process not having an abnormality 521 and an electrolysis process having an abnormality 522. An input of the feature extraction layer 420 may include the electrolysis process having the abnormality 522 and the electrolysis process information 410 acquired in real time, and an output of the feature extraction layer 420 may include the electrolysis process feature 432. An input of the prediction layer 440 may include the electrolyte features 431, the electrolysis process feature 432, and the detection time 433, and an output of the prediction layer 440 may include the updated operating parameters 450 of the potentiometer.

More descriptions on the prediction model, the electrolyte features, the electrolysis process information, and the electrolysis process feature may be found in the relevant descriptions in the previous descriptions (e.g., FIG. 4 and related descriptions thereof).

In some embodiments, the judgment layer of the prediction model may be obtained by separate training, and the feature extraction layer and the prediction layer of the prediction model may be obtained by joint training.

In some embodiments, the central control unit may obtain the judgment layer by separate training based on a large number of third training samples with a third label. The third training samples may include sample electrolysis process information, and the third label may include actual abnormalities corresponding to the third training samples.

In some embodiments, the third training samples may be determined based on historical data.

In some embodiments, the third label may be obtained by manual labeling. Merely by way of example, the operator may select a plurality of electrolysis cases of electrolysis failure or poor electrolysis effect (e.g., a thickness uniformity of the deposition body does not meet a requirement or the like) from the historical data, obtain a plurality of pieces of electrolysis process information from each electrolysis case in a chronological order, and judge the plurality of pieces of the electrolysis process information to determine the electrolysis process information that begins to appear an abnormality and annotate the electrolysis process information. For example, the third label of the electrolysis process information prior to the occurrence of the abnormality is 0, and the third label of the electrolysis process information after the occurrence of the abnormality is 1.

In some embodiments, the central control unit may input the third training samples into an initial judgment layer, iterate parameters of the initial judgment layer through training until a trained judgment layer satisfies a preset training condition, and obtain the trained judgment layer. The preset training condition may be a loss function less than a threshold, convergence, or a training period reaching a threshold. In some embodiments, the manner of iteratively updating the parameters of the judgment layer may include a stochastic gradient descent algorithm.

In some embodiments, the central control unit may obtain the feature extraction layer and the prediction layer by joint training based on a large number of fourth training samples with a fourth label. The fourth training samples may include the sample electrolysis process information, sample electrolyte features, and a sample detection time, and the fourth label is actual updated operating parameters of the potentiometer corresponding to the fourth training samples.

The details about the acquisition of the fourth training samples and the fourth label as well as the joint training of the feature extraction layer and the prediction layer may be found in the previous descriptions (e.g., FIG. 4 and related descriptions thereof) and will not be repeated here.

In some embodiments, an input of the prediction layer 440 may also include an electrode distance 540, as shown in FIG. 5. When the input of the prediction layer includes an electrode distance, the fourth training sample also includes a sample electrode distance.

In some embodiments, the sample electrode distance may be determined based on the sample electrolyte features. For descriptions on the electrode distance and a process for determining the electrode distance based on the electrolyte features may be found in a later related description.

According to some embodiments of the present disclosure, by using the electrode distance as the input of the prediction layer, the influence of the electrode distance on the updated operating parameters of the potentiometer is comprehensively taken into account, which is conducive to further improving the accuracy of the prediction model.

In some embodiments, as shown in FIG. 5, when the output of the judgment layer 511 is that the electrolysis process not having the abnormality 521, the prediction model may not output the updated operating parameters of the potentiometer, but output operating parameters (i.e., original operating parameters) 530 of the potentiometer. At the same time, the central control unit may control the potentiometer to operate with the original operating parameters.

In some embodiments, the central control unit may further determine a distance between the end of the microfine glass tube and the substrate based on the electrolyte features.

As previously described, when the anode of the potentiometer 403 is inserted into copper sulfate solution inside the microfine glass tube 404, and the cathode of the potentiometer 403 is connected to the substrate 405, a local electric field is formed between the microfine glass tube 404 and the substrate 405, and under the action of this local electric field, metal ions may be transformed to metal atoms. At this point, if the bottom end of the microfine glass tube is regarded as the anode and the substrate is regarded as the cathode, the distance between the end (i.e., the bottom) of the microfine glass tube and the substrate is the electrode distance.

In some embodiments, the central control unit may determine the distance between the end of the microfine glass tube and the substrate (i.e., the electrode distance) through a control table based on the electrolyte features.

The control table may be used to characterize a correlation between the electrolyte features and the electrode distances, with each set of electrolyte features corresponding to an electrode distance (hereafter referred to as a reference electrode distance). In some embodiments, the control table may be constructed based on experiments, historical data, or the like. For example, for the same set of the electrolyte features, the operator may conduct electrolysis tests using different electrode distances and use the electrode distance corresponding to best copper core structure deposition as the reference electrode distance. In some embodiments, the operator may determine the effect of the copper core structure deposition by, for example, examining the uniformity and smoothness of the appearance of the deposition body, the uniformity of the thickness of the deposition body, or examining the composition and purity of the deposition body.

Since the electrode distance also affects the electrolysis process (e.g., a small electrode distance may lead to an unstable electrolysis reaction or the like), which in turn affects the quality of the deposition body. Therefore, by determining an appropriate electrode distance according to the electrolyte features, the stability and safety of the electrolysis reaction can be further ensured, and the deposition effect can be improved.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

What is claimed is:

1. A meniscus-confined electrochemical deposition device for a heterogeneous metal core-shell microstructure, comprising a macroscopic moving platform, a microscopic moving platform, a copper core structural system, a shell-layer structural system, a probe adjustment unit, and a central control unit, wherein the macroscopic moving platform, the microscopic moving platform, the shell-layer structural system, and the central control unit are disposed on a vibration isolation platform;
the copper core structural system includes a microfine glass tube, a substrate, and a potentiometer, the microfine glass tube being configured to deliver an electrolyte, the substrate being configured to deposit a microstructure, and the potentiometer being configured to provide a three-electrode system to the copper core structural system;
the microfine glass tube is disposed on the probe adjustment unit, the probe adjustment unit is disposed on the macroscopic moving platform, and the macroscopic moving platform is configured to perform macro-range positional adjustment on the microfine glass tube; and the probe adjustment unit is configured to perform small-range positional adjustment on the microfine glass tube;
the shell-layer structural system includes an electrolytic cell, an electrochemical deposition power supply, and a plurality of reservoirs, a cathode of the electrochemical deposition power supply being connected to the substrate, and an anode of the electrochemical deposition power supply being connected to a sidewall of a pyrolytic graphite in the electrolytic cell, and the plurality of reservoirs supply a plurality of electrolytes required for core-shell deposition to the electrolytic cell via an electrolyte-driven pump, respectively;
the electrolytic cell is disposed on the microscopic moving platform, the microscopic moving platform being configured to perform mobile adjustment on the electrolytic cell and the substrate and the pyrolytic graphite within the electrolytic cell; and
the central control unit is electrically connected to electrical elements in the macroscopic moving platform, the microscopic moving platform, the copper core structural system, the shell-layer structural system, and the probe adjustment unit, and perform a coordinated control on the electrical elements.

2. The meniscus-confined electrochemical deposition device of claim 1, wherein the macroscopic moving platform includes a Y-axis moving system, a Z-axis moving system, and an X-axis moving system; and
the Z-axis moving system is disposed on the vibration isolation platform through a connecting member, the Z-axis moving system being provided with left and right pillars, the pillars together holding the Y-axis moving system, and the X-axis moving system being disposed on the Y-axis moving system.

3. The meniscus-confined electrochemical deposition device of claim 1, wherein the microscopic moving platform includes an XY-direction moving platform and a Z-direction moving platform; and
the XY-direction moving platform is disposed on the vibration isolation platform, and the Z-direction moving platform is disposed on the XY-direction moving platform.

4. The meniscus-confined electrochemical deposition device of claim 1, wherein the copper core structural system further includes a pressure extrusion device and an air delivery pipeline;
the pressure extrusion device is disposed on the vibration isolation platform, one end of the air delivery pipeline is connected to an outlet of the pressure extrusion device, and the other end of the air delivery pipeline is connected to the microfine glass tube; and
the shell-layer structural system further includes an electrolyte delivery pipeline and the electrolyte-driven pump, two ends of the electrolyte delivery pipeline being connected to the electrolytic cell and the plurality of reservoirs, respectively, and the electrolyte-driven pump being disposed on the electrolyte delivery pipeline.

5. The meniscus-confined electrochemical deposition device of claim 2, wherein the probe adjustment unit includes a micro-displacement adjustment mechanism, a yaw adjustment mechanism, and a fixing bracket; and
the fixing bracket is disposed on the X-axis moving system, the micro-displacement adjustment mechanism is disposed on the fixing bracket, the yaw adjustment mechanism is disposed on the micro-displacement adjustment mechanism, and the microfine glass tube is disposed on a bracket of the yaw adjustment mechanism.

6. A meniscus-confined electrochemical deposition method for a heterogeneous metal core-shell microstructure implemented based on the meniscus-confined electrochemical deposition device of claim 1, the method comprising:
injecting a copper sulfate solution into the microfine glass tube;
forming a two-electrode electrochemical structure of the copper core structural system by the potentiometer, and forming a three-electrode electrochemical structure of the shell-layer structural system by the electrochemical deposition power supply;
turning on a switch of the potentiometer to create a local electric field between the microfine glass tube and the substrate;
adjusting a position of the microfine glass tube using the probe adjustment unit and the macroscopic moving platform to maintain an orthogonal state between the microfine glass tube and the substrate;
extruding the copper sulfate solution placed inside the microfine glass tube into a deposition microzone of the substrate, controlling the microscopic moving platform to drive the substrate to move according to a meta-trajectory planning of a deposition body by the central control unit, and transforming metal ions to metal atoms under an action of the local electric field formed between the microfine glass tube and the substrate to form a copper metal complex metal deposition body and complete deposition of a copper core structure;
the central control unit controlling the macroscopic moving platform to drive the probe adjustment unit and the microfine glass tube out of the electrolytic cell; and
according to a design of a multilayer metal core-shell structure, the central control unit determining a thickness and a type of a metal core-shell layer, turning on the electrochemical deposition power supply, and controlling the electrolyte-driven pump to transport a metal solution in the plurality of reservoirs to the electrolytic cell in sequence according to a metal sequence of different types of metal core-shells to complete separate deposition of the different types of metal core-shells.

7. The meniscus-confined electrochemical deposition method of claim 6, wherein:
the forming a two-electrode electrochemical structure of the copper core structural system by the potentiometer includes:
inserting an anode of the potentiometer into the copper sulfate solution inside the microfine glass tube, and connecting a cathode of the potentiometer to the substrate disposed at a bottom of the electrolytic cell; and
the forming a three-electrode electrochemical structure of the shell-layer structural system by the electrochemical deposition power supply includes:
connecting the cathode of the electrochemical deposition power supply to the substrate, connecting the anode of the electrochemical deposition power supply to the sidewall of the pyrolytic graphite of the electrolytic cell, and placing a reference electrode of the electrochemical deposition power supply in the electrolytic cell without contact with the sidewall and the substrate.

8. The meniscus-confined electrochemical deposition method of claim 7, further comprising:
determining operating parameters of the potentiometer based on electrolyte features and controlling the potentiometer to operate at the operating parameters through the central control unit; the electrolyte features including an electrolyte property, an electrolyte concentration, and an electrolyte volume.

9. The meniscus-confined electrochemical deposition method of claim 8, wherein:
the meniscus-confined electrochemical deposition device further includes an electrolysis detection device, the electrolysis detection device being disposed on an inner wall of the electrolytic cell and being configured to obtain electrolysis process information of the electrolyte; and
the method further comprises:
determining updated operating parameters of the potentiometer through a prediction model based on the electrolysis process information and the electrolyte features at a detection time and controlling the potentiometer to operate at the updated operating parameters through the central control unit;
wherein the prediction model is a machine learning model, and the prediction model includes a feature extraction layer and a prediction layer.

10. The meniscus-confined electrochemical deposition method of claim 9, wherein the feature extraction layer and the prediction layer are obtained by joint training.

11. The meniscus-confined electrochemical deposition method of claim 10, further comprising:
determining whether or not there is an abnormality in an electrolysis process of the electrolyte through the prediction model based on the electrolysis process information acquired in real time through the central control unit; and
in response to determining that there is the abnormality in the electrolysis process, determining the updated operating parameters of the potentiometer through the prediction model.

12. The meniscus-confined electrochemical deposition method of claim 11, wherein an input of the prediction layer includes an electrode distance.

13. The meniscus-confined electrochemical deposition method of claim 6, wherein:
the position of the microfine glass tube is adjusted by the probe adjustment unit and the macroscopic moving platform, so that the microfine glass tube is located directly above a center of the substrate, and a distance between an end of the microfine glass tube and the substrate is in a range of 10 μm˜15 μm, an orthogonal state between the microfine glass tube and the substrate is maintained.

14. The meniscus-confined electrochemical deposition method of claim 13, further comprising:
determining the distance between the end of the microfine glass tube and the substrate based on electrolyte features by the central control unit.

15. The meniscus-confined electrochemical deposition method of claim 6, wherein:
the central control unit controls the macroscopic moving platform to drive the probe adjustment unit and the microfine glass tube out of the electrolytic cell and to move upwardly in a range of 10 cm˜12 cm.

16. The meniscus-confined electrochemical deposition method of claim 6, wherein:
the central control unit controls the electrolyte-driven pump to transport the metal solution in the plurality of reservoirs to the electrolytic cell through an electrolyte delivery pipeline in sequence according to the metal sequence of the different types of metal core-shells to complete the separate deposition of the different types of metal core-shells; and
in response to completion of deposition of each type of the metal core-shells, the central control unit controls the electrolyte-driven pump to reverse to empty a remaining metal solution in the electrolytic cell into a recovery reservoir.
